(19) United States
(12) Patent Application Publication
(10) Pub. No.: US 2026/0250613 A1
(43) Pub. Date: Aug. 27, 2026

(54) A PROCESS OF EXOTIC CRAFT WHISKY SPIRITS WITH REFRESHING CUES AND AROMATICS OF BEER

(71) Applicant: UNITED SPIRITS LIMITED, Bangalore (IN)

(72) Inventors: Narendra RAUT, Bangalore (IN); Vikram DAMODARAN, Bangalore (IN)

(21) Appl. No.: 18/577,379

(22) PCT Filed: Jul. 7, 2022
(86) PCT No.: PCT/IB2022/056262

§ 371 Date: Jan. 8, 2024

(30) Foreign Application Priority Data
Jul. 7, 2021 (IN) 202141030442

(51) Int. Cl. C12C 11/00; C12C 7/01; C12C 7/26; C12C 11/11

(52) U.S. Cl. CPC C12C 11/003; C12C 7/01; C12C 7/26; C12C 11/11

(57) ABSTRACT

The invention relates to process of preparation of flavorful craft whisky spirits from different types of beers using pot still distillation and maturation. The process is achieved from beers, including Ale, Lager, Porter, Pilsner, Stout and hybrid. The brew from beer making process is extended to tweaked double stage copper pot still distillation followed by primary and secondary maturation processes to produce varieties of exotic craft whisky spirits having refreshing cues and aromatics of beer. The process is unique with respect to addition of hops during mashing, top and bottom fermentation, conditioning and filtration before distillation, tweaking distillation to retain beer cues, maturation in varieties of casks or wood infusion and secondary maturation to impart desired natural flavors to infuse with characteristic beer aroma and refreshment cues.

### PRIORITY CLAIM

This application claims priority from the provisional application numbered 202141030442 filed with Indian Patent Office, Chennai on 7 Jul. 2021 entitled “A process of exotic craft whisky spirits with refreshing cues and aromatics of beer” , the entirety of which is expressly incorporated herein by reference.

### PREAMBLE TO THE DESCRIPTION

The following specification particularly describes the invention and the manner in which it is to be performed:

### DESCRIPTION OF THE INVENTION

### Technical field of the invention

The present invention relates to a unique process of preparation of flavorful craft whisky spirits from different types of beers by using pot still distillation and maturation. More particularly, the invention relates to the process of preparation of exotic craft whisky spirits from different types of beers such as Ale, Lager, Porter, Pilsner, Stout and hybrid by using double stage copper pot still distillation followed by primary and secondary maturation. The process results in different styles of aromatic craft whisky spirit having refreshing cues of beer thereby providing exotic whisky experience to the consumers.

### BACKGROUND OF THE INVENTION

Whisk(e)y is one of the most popular distilled alcoholic beverage categories, which is made from fermented grain mash. Various grains, such as, barley, corn, rye, rice, wheat etc. are used to produce a wide variety of whiskies where the grains used may be malted or non-malted. In order to enhance the taste, whisky is typically aged in wooden casks, more often in American oak casks or European oak casks once used for making Sherry wine. Generally, the concentration of ethanol in whisky lies within 36%-50% and whisky is usually colored with the addition of caramel or burned sugar.

Beer is another popular alcoholic beverage and the general process of making beer involves malting of barley, grinding of malted barley with specific grist ratio, followed by mixing the malt grist with water and -mashing. The step of mashing is carried out at elevated temperature of 65 degree Celsius and above for liquefaction and saccharification processes to convert complex starch into simple sugars. After mashing and at the stage of boiling, hops are being added to give characteristic flavor. Hops are the flowers, or cones, of a plant called Humulus lupulus and they keep beer fresher and are responsible for retaining head of foam in beer. Hops adds to refreshing aroma, unique flavor and slight bitterness to the beer.

The liquid extract-from the mashing process during the brewing of beer or whisky is called as wort, which contains the sugars such as maltose and maltotriose. Wort is cooled and subjected to yeast fermentation to convert sugar into alcohol. Wort also contains important amino acids and proteins to supply nitrogen to the yeast and contributes to beer head retention and flavor. During the fermentation, yeast converts simple sugars into alcohol, which results in flavorful beer after final conditioning and or racking (transferring it from one vessel to another)-. The final product, thereafter, gets filtered and bottled or served as fresh beer.

Flavor and quality of beer depends upon various factors such as the type of malted barley (light, medium, heavy roasted), adjuncts used (grains other than malted barley), fermentation type (top fermentation or bottom fermentation), strains of yeasts and different varieties of hops used. Therefore, depending upon the kind of processes or starting material used in the process of making beer, different styles of beers such as Ale, Lager, Porter, Pilsner, Stout and Hybrid are yielded.

The general process of making whisky is a kind of extension of beer making process with additional steps, such as, double stage copper pot distillation and maturation. However, there are additional difference in the process of making beer and whisky. Hops are not added in the whisky and further, like in the process of making beer, the steps of conditioning and filtration do not form part of process to make whisky.

Craft whisky is a kind of whisky, popular among the consumers due to its specific taste, flavor, and uniqueness. It can have a range of flavors and taste depending upon the process or flavor used to prepare it. Further, one of the possibilities could be to prepare craft whisky from beer wort with additional steps of distillation and maturation to produce varieties of craft whisky spirits having refreshing cues and aromatics of beer. The approach offers varieties of beer cues in whisky by modulation of both beer and whisky specific process parameters to create wide and exotic range of craft whiskies.

The Patent Application No. WO2019242637A1 entitled “Production method for hop liquor and hop liquor” discloses a production method that comprises steps of preparing a beer fermentation liquid, preparing a pre-treated beer liquor, aging, diluting and blending, and infusing hops. The hop liquor retains characteristics of liquor such as lightness and sweetness, has characteristics of hops such as the slightly bitter and fresh flavor of hops, and has good drinkability.

The Patent Application No. CA2740069A1 entitled “Ultrafast method for creating aged wood flavored alcoholic beverages” discloses a method of creating an aged, ethanol-containing beverage using pressure for distinct periods of time of less than 3 months and at least one wood piece to create a wood flavored alcoholic beverage similar to beverages aged 10 years to 30 years without losing any volume of product during the method.

The Patent Application No. OA18801A entitled “Flavor infused alcoholic beverage and method of making the same” discloses an alcoholic beverage having the sensory characteristics of a flavored distilled spirit. The method for making the alcoholic beverage includes suspending botanicals above a distilled spirit in a closed container and applying pressure to create interaction between the botanicals and distilled spirit.

The Patent Application No. JP2003265161A entitled “Method for producing beer-flavored whisky” discloses s a beverage capable of adjusting the alcohol content of a beer-flavored beverage without significantly impairing the beer flavor. This is achieved by distilling malt liquor using raw materials for producing ordinary beer, including hops, not malt for conventional whiskey, it contains beer-flavored but highly alcoholic portion and almost alcohol. This is a production method in which carbon dioxide gas is sealed in both after separating into beverage.

Even though a wide variety of whisky is available in the market, which claim to be craft whisky, there is no reported process available today to convert wort from beer making process and extend the same to whisky process of distillation and maturation (primary and secondary) to produce varieties of craft whisky spirits having refreshing cues and aromatics of beer.

### SUMMARY OF THE INVENTION

The present invention overcomes the drawbacks of existing process of preparation of wide variety of whisky spirits from different types of beers. The process is an extension of preparation of beer with additional steps to impart specific flavor to obtain craft whisky.

The process of the present invention mainly comprises the steps of malting, milling, mashing, cooling, addition of hops, addition of Brewer's and distiller's yeasts with top or bottom fermentation depending on flavor required, conditioning, filtration before distillation, wood infusion during primary maturation and finishing through secondary maturation.

The process of preparation of flavorful craft whisky spirits comprises the steps of malting the barley grains such as light, medium, or heavily roasted malts. The malted barley is milled and mixed with adjuncts such as rice, corn, wheat, rye or ragi to give characteristic flavor of the adjuncts. The milled barley grains are subjected to mashing to achieve liquefaction and saccharification process during which the complex starch is converted into simple sugars at a temperature of 65° C. or above. At this stage, the barley mash is mixed with adjunct mash and hops are added to impart the characteristic flavor. The wort thus obtained is cooled followed by fermentation.

The fermentation included either top or bottom fermentation based on the required flavor using different types of yeast such as Brewer's yeast, Distiller's yeast, and mixture of both to obtain the varieties of flavor. The fermentation results in conversion of simple sugars to alcohol. This is followed by subjecting the fermented wort to conditioning followed by filtration. After filtration, the filtered wort is subjected to double stage copper pot distillation to retain beer flavor and to achieve alcohol strength above 60% v/v. The double stage copper pot distillation involves the use of vide range of beers such as Ale, Lager, Porter, Pilsner, Stout and hybrid to produce the whisky with characteristic beer aromatics than the conventional process. The distillate obtained during this step is called as new make spirit and retains malty characters along with the characteristic refreshing aroma and taste of beer such as sweet, floral, fruity, citrous, malty, chocolaty of different style of brew/wort used and along with hops. Finally, the new make spirit is subjected to maturation processes, which includes primary and secondary maturation.

The wooden casks made from American or European oak or vats made from Indian wood with different level of wood charring or by wood infusion process using American, European and Indian wood in different forms such as chips, powder, staves and spirals and having varied levels of toasting including light, medium, heavy and charred are added during the primary maturation process. The selection of type of wood, concentration, time, and temperature of infusion is carefully carried out to compliment right woody notes to the new make spirit.

This is followed by secondary maturation process in casks for providing different natural cues to yield exotic craft whisky spirit. The casks are optionally treated or conditioned with different spirits such as wines, rums, brandies, peated or different types of whiskies and, fruits, spices, herbs and botanical extracts to incorporate natural cues in craft whisky spirit.

After maturation, the resultant craft whisky spirits comprise characteristic aroma and refreshment cues of beer along with the hint of different woody notes and multiple layers with an array of flavors including sugar maple, cherry wood etc. through various finishing techniques.

The process of the present invention is unique with respect to addition of hops and secondary maturation which results in multiple layers with different flavors such as sugar maple, cherry wood etc. The whisky spirit produced by the unique process of the present invention results in aromatic craft-whisky spirits having refreshing cues of beer.

### BRIEF DESCRIPTION OF DRAWINGS

FIG. 1 illustrates a conventional process of making whisky.

FIG. 2 illustrates a unique process of making craft whisky according to an embodiment of the invention.

FIGS. 3a and 3b illustrates the profile of sensory attributes of craft whisky prepared by the extension of Ale beer process and the regular malt whisky.

### DETAILED DESCRIPTION OF THE INVENTION

In order to more clearly and concisely describe and point out the subject matter of the claimed invention, the following definitions are provided for specific terms, which are used in the following written description.

The term “Beer” refers an alcoholic drink made from yeast-fermented malt flavored with hops.

The term “Brewing” refers to the production of beer by steeping a starch source (commonly cereal grains, the most popular of which is barley) in water and fermenting the resulting sweet liquid with yeast.

The term “Distillation” refers to the selective boiling and subsequent condensation of a component in a liquid mixture.

The term “Grist” refers to malt and cereal that is ground (milled) by a malt mill at the beginning of the brewing process to get ground grain with desired particle size.

The term “Malting” refers to a process of steeping, germinating and drying grain to convert it into malt.

The term “Maturation” refers to a step, in preparation of whisky and is performed to remove harsh flavors from the raw alcohol while adding distinct flavor characteristics found in the wood of cask.

The term “Milling” refers to a process wherein grains are separated from any objects such as stones that are not meant to be in the mix and could potentially damage the machine.

The term “Whisky” refers to a distilled alcoholic beverage made from fermented grain mash.

The term “Wort” refers to a liquid extracted from the mashing process during the whisky process or brewing of beer.

The present invention relates to a process of preparation of flavorful craft whisky spirits from different types of beers, including but not restricted to, Ale, Lager, Porter, Pilsner, Stout and hybrid by using double stage copper pot still distillation followed by maturation. The wort from beer making process is extended in the present invention to distillation and maturation including primary and secondary maturation to produce varieties of craft whisky spirits having refreshing cues and aromatics of beer. This unique process of preparation of whisky spirit disclosed in the present invention relates to the final product having characteristic of beer flavor. This is achieved by using a combination and extension of process of beer production with a unique set of steps.

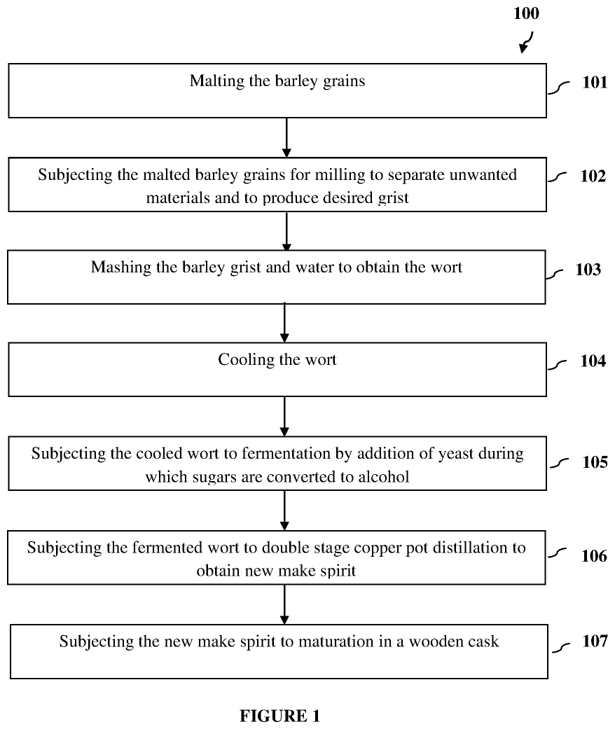

FIG. 1 illustrates a conventional process of making whisky. As depicted in FIG. 1, the process (100) of making whisky involves the step (101) of malting, which starts with moistening, partial sprouting, or germination and arresting germination of the grain such as barley after drying. The process of malting activates the amylase enzymes that converts the barley's starches to sugars. This is followed by step (102) of milling, during which, the grains are separated from unwanted objects such as stones that are not meant to be in the mix and converted in grist of desired ratio course, medium and fine particles of grain. At step (103) of mashing, the grist is mixed with water and cooked to carry our liquefaction and saccharification to get simple sugars extracted in a slurry called wort. Once maximum amount of sugar is extracted, the wort is subjected to cooling at step (104). At a step of (105), yeast is added to the wort to initiate the process of fermentation during which simple sugars are converted into alcohol. At step (106), the fermented product having alcohol is subjected to double stage pot still distillation to obtain new make spirit having increased alcohol strength with desired volatile components contributing to characteristic flavor of new make spirit. Finally, at step (107), the new make spirit is subjected to maturation of whisky in wooden casks stored in warehouses.

The unique process of making craft whisky, in the present invention, involves additional steps of using hops during mashing, unique steps of top and bottom fermentation as per the required flavors, conditioning and filtration of brew, and primary and secondary maturation processes using either different wooden casks or wood infusion process and secondary maturation, which included various finishing techniques.

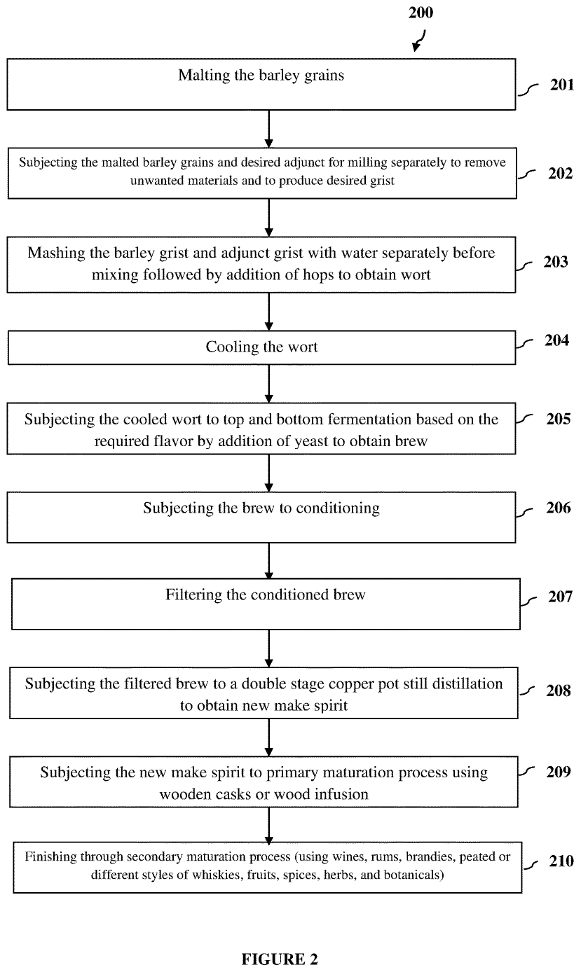

FIG. 2 illustrates a unique process of making craft whisky according to an embodiment of the invention. As depicted in FIG. 2, the steps involved in preparation of new craft whisky process include malting, milling, mashing, cooling, addition of hops, addition of Brewer's and distiller's yeasts with top or bottom fermentation depending on flavor required, conditioning, filtration before distillation, wood infusion and finishing through secondary maturation. The process (200) of making craft whisky of the present invention starts with a step (201) of malting the barley grains. The process involves the use of different types of malted barley such as light, medium, or heavily roasted malts. This is followed by a step (202) of milling. The malted barley is mixed with adjuncts such as rice, corn, wheat, rye or ragi to give characteristic flavor of the adjuncts. However, the malted barley and adjuncts are milled and mashed separately before mixing. At step (203), the milled barley grains are subjected to mashing to achieve liquefaction and saccharification process during which the complex starch is converted into simple sugars at a temperature of 65° C. or above. The barley mash is mixed with adjunct mash and hops are added to impart characteristic flavor. The addition of hops during the mashing step is a unique step of the present invention as far as whisky making is concerned to yield sweet and a flavorful wort. At step (204), the wort is subjected to cooling before fermentation. At step (205), the cooled wort is subjected to fermentation by addition of yeast during which the simple sugars are converted to alcohol. The fermentation of the present invention involves top and bottom fermentation based on the required flavor using different types of yeast such as Brewer's yeast, Distiller's yeast, and mixture of both to obtain the varieties of flavor. At step (206), the fermented brew or wort is subjected to conditioning followed by filtration. At step (207), the filtered wort is subjected to double stage copper pot distillation. During the double stage copper pot still distillation, the process parameters are tweaked to retain beer flavor and to achieve alcohol strength above 60% v/v. The distillate obtained during this step is called as new make spirit, retains malty characters along with the characteristic refreshing aroma and taste of beer such as sweet, floral, fruity, citrous, malty, chocolaty of different style of brew/wort used and along with hops. At step (208), the new make spirit is subjected to maturation processes, which includes primary and secondary maturation.

The primary maturation is achieved either using wooden casks made from American or European oak (once used or virgin) or vats made from Indian wood with different level of wood charring or by wood infusion process using American, European and Indian wood in different forms such as chips, powder, staves and spirals and having varied levels of toasting including light, medium, heavy and charred. The selection of type of wood, concentration, time, and temperature of infusion is carefully carried out to compliment right woody notes to the new make spirit.

According to an embodiment of the invention, the infusion process is carried out with wood in different forms at concentration from 0.1 to 1.0% w/v, temperature from 25 to 50 degree Celsius and infusion time from 2 to 16 weeks and in presence of oxygen environment with pressure up to 0.5 kg/cm². Further, some of the varieties are subjected to secondary maturation in casks for providing different natural cues to yield exotic craft whisky spirit. The obtained casks are optionally treated or conditioned with different spirits such as wines, rums, brandies, peated or different types of whiskies and, fruits, spices, herbs and botanical extracts to incorporate natural cues in craft whisky spirit. The casks are also finished with American or European oak with different toasting levels and in multiple forms such as wood chips, wood powder, wood staves or wood spirals from cherry, sugar maple or amburana. The resultant craft whisky spirits comprise of characteristic aroma and refreshment cues of beer along with the hint of different woody notes and multiple layers with an array of flavors including sugar maple, cherry wood etc. through various finishing techniques for new consumer experience.

In the present invention, different types of beers such as but not limited to Ale, Lager, Porter, Pilsner, Stout and hybrid are processed to produce distilled spirit using tweaked double stage copper pot still distillation process. The distillate of the said process retains malty characters along with the characteristic refreshing aroma and taste of beer such as sweet, floral, fruity, citrous, malty, chocolaty of different style of brew/wort used and along with hops. The presence of lactic acid and acetic acid in the distillate enhances the fruity flavors of whisky spirits.

The process of making craft whisky is unique with respect to extension of beer brew/wort with hops following pot still distillation and maturation to yield flavorful craft whisky spirits. The process involves the use of vide range of beers such as Ale, Lager, Porter, Pilsner, Stout and hybrid for double stage copper pot distillation to produce the whisky with characteristic beer aromatics than the conventional process. The process comprises the unique step of infusion using wood in different forms at concentration from 0.1 to 1.0% w/v, temperature from 25° C. to 50° C. with an infusion time from 2 to 16 weeks and in presence of oxygen environment with pressure up to 0.5 kg/cm².

The following example is offered to illustrate various aspects of the invention. However, the examples are not intended to limit or define the scope of the invention in any manner.

The extension of beer process to craft whisky as per the process of the present invention improves the sensorial attributes of the craft whisky. The sensorial attributes determine the quality, which alters with the age of the craft whisky.

The sensory attributes of the craft whisky and the regular malt whisky are compared.

### Example 1

### Analysis of Sensorial Attributes of the Craft Whisky and the Regular Malt Whisky

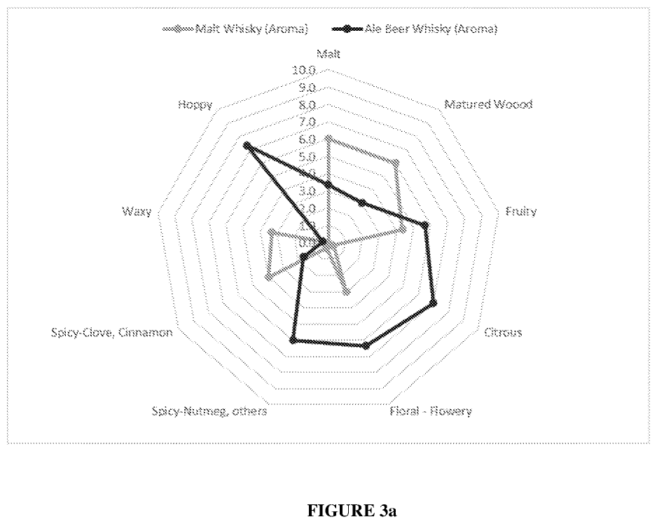

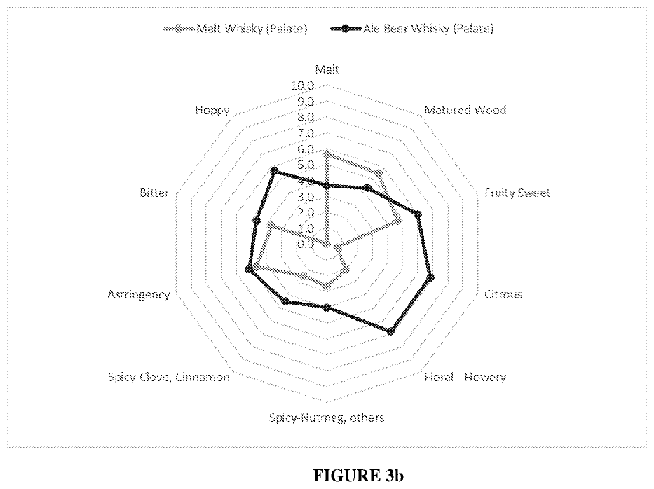

FIGS. 3a and 3b illustrates the profile of sensory attributes of craft whisky prepared by the extension of Ale beer process and the regular malt whisky. The profile of the sensory attributes of the craft whisky prepared by the extension of Ale beer process is compared with the regular malt whisky by the experienced in-house sensory panel. The attributes such as fruity, floral, spicy, waxy and hoppy are compared. The results indicated that the spicy (nutmeg type), fruity sweet and floral attributes along with citrous, hoppy characters are enhanced and adds refreshing cues to whisky experience. FIG. 3a illustrates the differentiation of sensory attributes in aromatic and FIG. 3b illustrates the differentiation of sensory attributes in taste on palate.

The whisky spirits produced by the new process of the present invention results in refreshing characteristic beer aroma and refreshment cues and also results in production of different styles of aromatic craft-whisky spirits having refreshing cues of beer.

We Claim,

1. A process of preparation of exotic craft whisky spirits, the process (200) comprises the steps of:
a. malting the barley grains (201);
b. milling the malted barley grains and mixing with one or more adjuncts such as rice, corn, wheat, rye or ragi to give characteristic flavor of the adjuncts (202);
c. mashing the milled barley grains to achieve liquefaction and saccharification and adding one or more hops to impart a characteristic flavor (203);
d. cooling a wort before subjecting to fermentation (204);
e. subjecting the cooled wort to fermentation by adding Brewer's yeast or Distiller's yeast or both during which the simple sugars are converted to alcohol (205);
f. subjecting the fermented wort to conditioning followed by filtration (206);
g. subjecting the filtered wort to double stage copper pot distillation during which beer flavor is retained and alcohol strength above 60% v/v is achieved (207); and
h. subjecting the new make spirit to primary maturation using one or more wooden casks and secondary maturation to achieve natural cues to yield exotic craft whisky spirit (208) wherein a characteristic aroma and refreshment cues of beer is imparted into said exotic craft whisky spirit along with the hint of one or more woody notes and flavors.

2. The process as claimed in claim 1, wherein the malted barley grains are selected from a group comprising light, medium, or heavily roasted malts.

3. The process as claimed in claim 1, wherein addition of the hops yields a sweet and a flavorful wort.

4. The process as claimed in claim 1, wherein the fermentation comprises top and bottom fermentation selected based on the flavor.

5. The process as claimed in claim 1, wherein one or more type of beer selected from a group comprising Ale, Lager, Porter, Pilsner, Stout and hybrid are used for double stage copper pot distillation.

6. The process as claimed in claim 1, wherein the distillate after pot distillation retains malty characters along with the characteristic refreshing aroma and taste of beer such as sweet, floral, fruity, citrous, malty or chocolaty.

7. The process as claimed in claim 1, wherein the primary maturation is achieved using one or more types of wooden casks made from American oak, European oak, virgin oak, once used casks, cherry wood cask or vats made from Indian Sal wood, and with different level of charring.

8. The process as claimed in claim 1, wherein the primary maturation is achieved using wood in one or more forms at a concentration from 0.1% to 1.0% w/v, temperature from 25° C. to 50° C. at infusion time from 2 to 16 weeks and in presence of oxygen environment with pressure up to 0.5 kg/cm².

9. The process as claimed in claim 1, wherein the secondary maturation imparts craft whisky spirits with a characteristic aroma and multiple layers with an array of flavors and the secondary maturation comprises of:
a. finishing in cask previously used for wine maturation, rum maturation, peated whisky maturation, bourbon or American whisky maturation;
b. finishing in cask with fusion of American or European oak with varied toasting levels and in one or more forms selected from wood chips, wood powder, wood staves or wood spirals;
c. finishing in cask with fusion of one or more varieties of woods selected from cherry, sugar maple or amburana.
d. using the casks treated or conditioned with fruits, spices, herbs and botanical extracts in liquid creation.

10. The process as claimed in 1, wherein the craft whisky is further subjected to the process of secondary maturation as in claim 9 to create one or more varieties of flavours.

11. The process as claimed in 1, wherein the process provides multiple varieties of whisky flavour blocks which on blending provides elevated levels craft whisky experience to the consumers.
